(19) United States
(12) Patent Application Publication
(10) Pub. No.: US 2025/0323351 A1
(43) Pub. Date: Oct. 16, 2025

(54) THERMAL RUNAWAY PREVENTION FILM AND METHOD FOR MANUFACTURING THE SAME

(71) Applicant: Ntrium Inc., Siheung-si (KR)

(72) Inventors: Se Young JEONG, Siheung-si (KR); Ju Young LEE, Siheung-si (KR); Ki Seok KHO, Siheung-si (KR); Byung Sun LEE, Siheung-si (KR); Yong Won MIN, Siheung-si (KR); Tae Hun LEE, Siheung-si (KR)

(21) Appl. No.: 19/002,270

(22) Filed: Dec. 26, 2024

(30) Foreign Application Priority Data
Apr. 15, 2024 (KR) 10-2024-0049839

(51) Int. Cl. H01M 10/658; B32B 5/18; B32B 7/09; B32B 7/12

(52) U.S. Cl. CPC H01M 10/658; B32B 5/18; B32B 7/09; B32B 7/12; B32B 2307/302; B32B 2307/304; B32B 2307/3065; B32B 2457/10

(57) ABSTRACT

A thermal runaway prevention film is proposed. The film may include a heat insulation layer to block heat transfer, and a fireproof layer disposed to face with the heat insulation layer. The film may also include sealing member that seals the heat insulation layer and the fireproof layer, wherein the sealing member may have a string shape. The heat insulation layer, the fireproof layer, and the sealing member may include a flame-retardant material. The fireproof layer may include a first fireproof layer disposed to face with one surface of the heat insulation layer, and a second fireproof layer disposed to face with the other surface of the heat insulation layer.

### CROSS-REFERENCE TO RELATED APPLICATION

This application claims priority to Korean Patent Application No. 10-2024-0049839 filed on Apr. 15, 2024, the entirety of which is incorporated herein by reference for all purposes.

### TECHNICAL FIELD

The present disclosure relates to a thermal runaway prevention film and method for manufacturing the same.

### BACKGROUND

A secondary battery is capable of being charged and discharged. The secondary battery is not only used in small electronic devices such as mobile phones and laptop computers but also used as a power source for energy storage systems (ESS), electric vehicles (EV), and hybrid electric vehicles (HEV).

### SUMMARY

The embodiments of the present disclosure have been devised in light of the aforementioned background to provide a thermal runaway prevention film and its manufacturing method with improved thermal insulation performance and resistance to interlayer delamination.

The embodiments of the present disclosure offer the advantage that the film does not experience interlayer delamination, even when exposed to flames.

Additionally, the embodiments provide the advantage of improved thermal insulation performance.

Furthermore, the embodiments have the advantage of enabling the production of films with excellent adhesion while simplifying the manufacturing process and reducing production costs.

In accordance with one embodiment of the present disclosure, an thermal runaway prevention film comprising: a heat insulation layer to block heat transfer; a fireproof layer disposed to face with the heat insulation layer; and a sealing member that seals the heat insulation layer and the fireproof layer, wherein the sealing member has a string shape, the heat insulation layer, the fireproof layer, and the sealing member include a flame-retardant material, wherein the fireproof layer includes: a first fireproof layer disposed to face with one surface of the heat insulation layer, and a second fireproof layer disposed to face with the other surface of the heat insulation layer.

Further, the heat insulation layer and the multiple fireproof layers may be sealed by the sealing member without using an adhesive, and the heat insulation layer and the fireproof layer directly face with each other.

Further, at least one of the Heat insulation layer and the multiple fireproof layers may contain a foaming agent.

Further, the thermal runaway prevention film may further comprise an air gap that slows temperature rises of the heat insulation layer and the multiple fireproof layers, wherein the air gap is formed between the heat insulation layer and the fireproof layer, and the air gap reduces a pressure between the heat insulation layer and the fireproof layer.

Further, the heat insulation layer may include an opposing surface facing with the fireproof layer, the fireproof layer includes an opposing surface facing with the heat insulation layer, and the air gap is provided by a plurality of recesses formed on at least one of the opposing surface of the heat insulation layer and the opposing surface of the fireproof layer.

Further, the sealing member may include: a first connection part that connects the heat insulation layer and the fireproof layer to each other on one side of the heat insulation layer, and a second connection part that connects the heat insulation layer and the fireproof layer to each other on the other side of the heat insulation layer, wherein the air gap is provided by bending at least one of the heat insulation layer and the fireproof layer between the first connection part and the second connection part

Further, the heat insulation layer may have a thermal conductivity ranging from about 0.001 W/mK to 10 W/mK.

Further, the fireproof layer may correspond to flame retardant grades 1 to 3 according to KS standard and meets V0 and 5VA ratings according to UL 94 standard.

Further, the thermal runaway prevention film may further comprise an adhesive disposed between the heat insulation layer and the fireproof layer to adhering to the heat insulation layer and the fireproof layer, wherein an area of the adhesive in contact with the heat insulation layer or the fireproof layer is less than half of a total area between the heat insulation layer and the fireproof layer.

Further, the fireproof layer may include a third fireproof layer disposed between the first fireproof layer and the second fireproof layer, and wherein the heat insulation layer includes: a first heat insulation layer disposed between the first fireproof layer and the third fireproof layer, and a second heat insulation layer disposed between the third fireproof layer and the second fireproof layer.

Further, the thermal runaway prevention film may further comprise a conductive layer that transfers heat in at least one of the heat insulation layer and the fireproof layer, wherein the conductive layer is disposed between the first fireproof layer and the heat insulation layer.

Further, the sealing member may essentially consist of a flame-retardant thread that does not burn.

Further, a method for manufacturing a thermal runaway prevention film performed by a manufacturing apparatus, may comprise: a layer providing step of providing a heat insulation layer blocking heat transfer and including a flame-retardant material, and multiple fireproof layers disposed to face with the heat insulation layer, also including a flame-retardant material by adsorbing air adjacent to surfaces of the heat insulation layer and the fireproof layers; and a sealing step of sealing the heat insulation layer and the multiple fireproof layers by stitching the heat insulation layer with the multiple fireproof layers using a sealing member.

Further, the method for manufacturing the thermal runaway prevention film may further comprise: a cutting step of cutting the heat insulation layer and the multiple fireproof layers into a predetermined size; and a laminating step of laminating the heat insulation layer between the multiple fireproof layers.

Further, in the sealing step, the heat insulation layer and the multiple fireproof layers may be laminated in the laminating step are sealed using a sealing member.

### BRIEF DESCRIPTION OF THE DRAWINGS

FIG. 1 is a perspective view conceptually illustrating the thermal runaway prevention film of the first embodiment of the present disclosure.

FIG. 2 is a cross-sectional view conceptually illustrating the thermal runaway prevention film shown in FIG. 1.

FIG. 3 is a flowchart illustrating a method for manufacturing a thermal runaway prevention film according to the first embodiment of the present disclosure.

FIG. 4 is a perspective view conceptually illustrating the thermal runaway prevention film of the second embodiment of the present disclosure.

FIG. 5 is a bottom view of the heat insulation layer in FIG. 3.

FIG. 6 is a bottom view of the fireproof layer in FIG. 3.

FIG. 7 is a perspective view conceptually illustrating the thermal runaway prevention film of the third embodiment of the present disclosure.

FIG. 8 is a perspective view conceptually illustrating the thermal runaway prevention film of the fourth embodiment of the present disclosure.

### DETAILED DESCRIPTION

Commonly used types of secondary batteries include lithium-ion batteries, lithium polymer batteries, nickel-cadmium batteries, nickel-hydride batteries, and nickel-zinc batteries. The operating voltages of the battery cells in these secondary batteries approximately ranges from 25V to 42V. To adjust the output voltage and energy capacity, secondary batteries include multiple battery cells. The number of these battery cells can be varied depending on the required output voltage or charge/discharge capacity.

When a secondary battery is repeatedly charged and discharged, a swelling that the internal battery cells expand may occur. Swelling can result from various causes, such as excessive charging, excessive discharging, short circuits, or exposure to high temperatures, etc, leading to a shortened battery lifespan, reduced capacity, decreased performance, and even safety hazards such as fires or explosions.

To prevent an thermal runaway such as ignition or explosions caused when a secondary battery ignites or explodes, a thermal runaway prevention film may be provided for the battery cells. In particular, when a secondary battery is used in an electric vehicle requiring to have high output voltage and energy capacity, the thermal runaway prevention film is applied to the secondary battery. This film prevents thermal runaway in the battery in the event of a fire in the electric vehicle.

Typically, a thermal runaway prevention film includes of multiple layers, each serving a different function. Conventionally, an adhesive such as adhesive tapes or glue was used to bond these multiple layers. However, the cost of establishing mass-production facilities for producing adhesive tapes or glue is approximately 4 to 5 billion KRW per facility. Additionally, it generally takes an average of nine months to set up such mass-production facilities. Since a significant amount of cost and time is needed in an additional process to produce a lot of adhesives, which are not essential to produce a film, this method poses economic inefficiencies.

Furthermore, in the manufacturing process of conventional thermal runaway prevention films, steps such as producing adhesives, producing fireproof layers and resin, laminating the heat insulation layer, and then laminating the fireproof layer are carried out sequentially. This sequence requires that each preceding step must be completed before the subsequent step proceed, leading to convenience. Additionally, losses occurred at each process step, necessitating monitoring and inventory management for these losses, which incur further inconvenience for the manufacturing process.

Additionally, using adhesive tapes or adhesives to bond multiple layers introduces complexity to the manufacturing process. For example, when bonding five layers, adhesives or adhesive tapes need to be applied to a total of four layers, requiring the adhesive application process to be repeated four times, making the process complicated. As previously mentioned, it is not possible to bond multiple layers simultaneously. The upper layers can only be bonded after the lower layers is bonded, resulting in requiring a significant amount of time.

Additionally, the process of bonding multiple layers using adhesive tapes or adhesives had the issue of making interlayer delamination more easily. Since adhesive tapes or adhesives are not flame-retardant materials, when the thermal runaway prevention film is exposed to flames, the adhesive tapes or adhesives typically melts, losing their bonding function and causing interlayer delamination. The thermal runaway prevention film requires multiple layers with different functions to be bonded together to perform its intended function. However, if interlayer delamination occurs, the film cannot fulfill its purpose. This inability to prevent interlayer delamination can result in the failure to stop thermal runaway in electric vehicle batteries.

Additionally, materials such as epoxy or acrylate were conventionally used as adhesive tapes or adhesives. However, these materials poses the problem of emitting harmful substances and carbon during the coating process on the film.

Hereinafter, specific embodiments for implementing the technical idea of the present disclosure will be described in detail with reference to the drawings.

In addition, in describing the present disclosure, when it is determined that detailed descriptions of known configurations or functions may obscure the gist of the present disclosure, the detailed descriptions will be omitted.

Moreover, it should be understood that when a component is referred to as being ‘laminated to’, or ‘opposed to’ another component, it may be directly laminated to, or opposed to another component, but other components may exist between the components.

The terms used in the present specification are only used for describing the specific embodiments and are not intended to limit the present disclosure. Singular expressions include plural expressions unless the context clearly indicates otherwise.

In addition, in the present specification, expressions such as upper, lower, side, etc. are described based on the drawings, and it is made clear in advance that they may be expressed differently if the direction of the object is changed. For the same reason, some components in the accompanying drawings are exaggerated, omitted, or schematically illustrated, and the size of each component does not entirely reflect the actual size.

Further, terms including ordinal numbers, such as first, second, etc., may be used to describe various components, but the components are not limited by these terms. These terms are only used to distinguish one component from another.

The meaning of “including” used in the present specification specifies specific features, regions, integers, steps, operations, elements and/or components, and does not exclude the presence or addition of other specific features, regions, integers, steps, operations, elements, components, and/or groups.

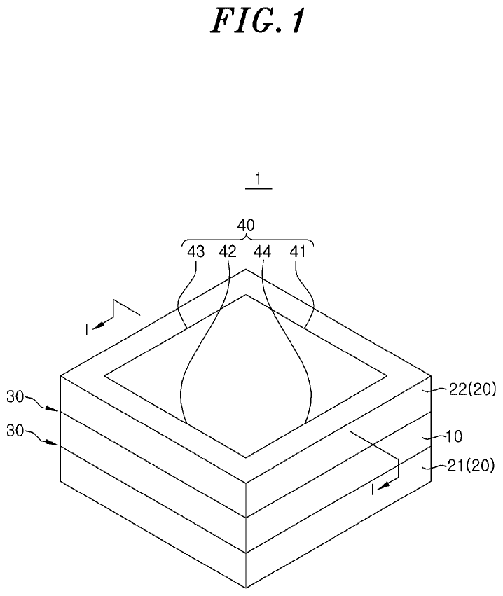

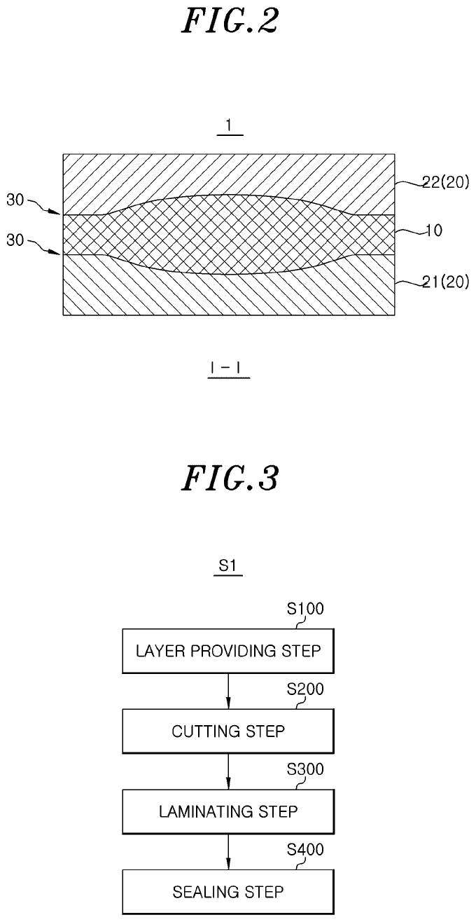

Hereinafter, the thermal runaway prevention film 1 according to an embodiment of the present disclosure will be described with reference to FIG. 1. The thermal runaway prevention film 1 can protect the battery of an electric vehicle from melting even if it is engulfed in flames. The thermal runaway prevention film 1 can be provided in various thicknesses. For example, the thickness of the thermal runaway prevention film 1 may range from 2 mm to 6 mm. The tensile strength of the thermal runaway prevention film 1 may range from 5 MPa to 15 MPa. As a more specific example, the tensile strength of the thermal runaway prevention film 1 may be 10 MPa. The thermal conductivity of the thermal runaway prevention film 1 may range from 0.0272 W/mK to 0.0372 W/mK. The thermal runaway prevention film 1 can endure temperatures of 1000° C. for up to 7 minutes. The thermal runaway prevention film 1 may include a heat insulation layer 10, a fireproof layer 20, an air gap 30, and a sealing member 40.

The heat insulation layer 10 can block heat transfer. By preventing heat transfer, the heat insulation layer 10 can help maintain a more stable temperature even when the electric vehicle battery is engulfed in flames. The heat insulation layer 10 may include flame-retardant materials and can have a thermal conductivity ranging from 0.001 W/mK to 10 W/mK.

The heat insulation layer 10 may contain a foaming agent (not shown). The foaming agent can cause the heat insulation layer 10 to expand. The heat insulation layer 10 may have an uneven surface. Although the heat insulation layer 10 expands due to the foaming agent, delamination between layers may not occur because the heat insulation layer 10 and the fireproof layer 20 are sealed by the sealing member 40.

Referring to FIG. 3, one surface of the heat insulation layer 10 can be designated as the opposing surface of heat insulation layer 10a. This opposing surface of heat insulation layer 10a may face the fireproof layer 20. The opposing surface of heat insulation layer 10a may be provided with a plurality of recesses. These recesses can form the air gap 30.

The fireproof layer 20 can protect the electric vehicle battery from burning. The fireproof layer 20 may be disposed beneath the heat insulation layer 10 and may contain a foaming agent. The fireproof layer 20 can have the same size as the heat insulation layer 10. The fireproof layer 20 may include materials with flame retardant grades 1 to 3 according to KS standards and materials corresponding to V-0 and 5VA ratings under UL 94 standards. The heat insulation layer 10 and the fireproof layer 20 can be sealed by the sealing member 40 without using adhesive 50 and may directly face each other.

The fireproof layer 20 can be provided in multiple layers. The fireproof layer 20 may include a first fireproof layer 21 and a second fireproof layer 22. The first fireproof layer 21 may be disposed beneath the heat insulation layer 10, while the second fireproof layer 22 may be disposed above the heat insulation layer 10. Both the first fireproof layer 21 and the second fireproof layer 22 can have the same size as the heat insulation layer 10. The first fireproof layer 21, the heat insulation layer 10, and the second fireproof layer 22 may be stitched and bonded together by the sealing member 40. For example, the sealing member 40 can stitch the edges of the first fireproof layer 21, the heat insulation layer 10, and the second fireproof layer 22.

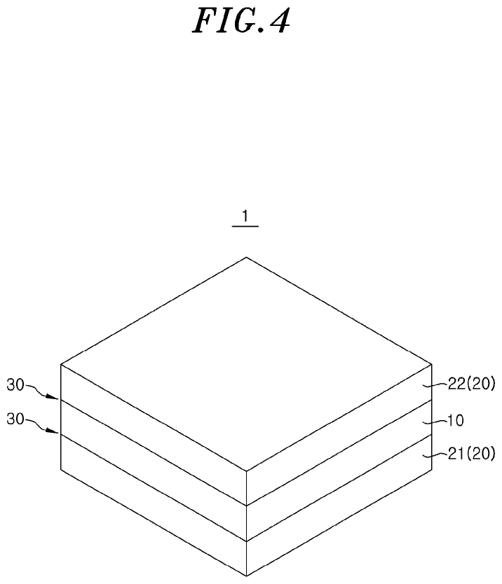

Referring to FIG. 4, the opposing surface of fireproof layer 20a is provided on the fireproof layer 20 and can face the heat insulation layer 10. A plurality of recesses can be formed on the opposing surface of fireproof layer 20a, which can create the air gap 30.

The air gap 30 can be a gap formed between the heat insulation layer 10 and the fireproof layer 20. The heat insulation layer 10 and the fireproof layer 20 may not be completely adhered, allowing the air gap 30 to be formed between the heat insulation layer 10 and the fireproof layer 20. The formation of the air gap 30 can enhance the thermal insulation performance of the thermal runaway prevention film 1. Air can be contained within the air gap 30. Air gap 30 may reduce the pressure between the heat insulation layer 10 and the fireproof layer 20.

The air gap 30 can be formed when one or more of the heat insulation layer 10 and the fireproof layer 20 bends between a first connection part 41 and a second connection part 42, which will be described later. For example, the air gap 30 may be created by multiple fireproof layers 20 bending in different directions. Additionally, the air gap 30 can be formed because the surfaces of the heat insulation layer 10 and the fireproof layer 20 are not completely even. In other words, if the surfaces of the heat insulation layer 10 and the fireproof layer 20 are not smooth, small gaps may occur between the two layers, and these gaps can act as the air gap 30.

The sealing member 40 can seal the heat insulation layer 10 and the fireproof layer 20. For instance, the sealing member 40 can stitch the edges of the heat insulation layer 10 and the fireproof layer 20 to seal them together. The sealing member 40 can extend along the edge of the fireproof layer 20 at a predetermined distance from the edge. Additionally, the sealing member 40 can extend in a shape corresponding to the edge of the fireproof layer 20.

The sealing member 40 can include flame-retardant materials. For example, the sealing member 40 may include aramid, non-crimped glass (NCG), glass fiber, and silica fiber. The sealing member 40 can have a string shape, such as a thread. The sealing member 40 may consist of a flame-retardant thread. The sealing member 40 does not melt even when the thermal runaway prevention film 1 is exposed to flames, preventing the heat insulation layer 10 and the fireproof layer 20 from delaminating. Unlike traditional adhesives 50, the sealing member 40 remains intact during battery fires, ensuring the integrity of the thermal runaway prevention film 1 even in extreme conditions. The sealing member 40 can include the first connection part 41, the second connection part 42, a third connection part 43, and a fourth connection part 44.

The first connection part 41 can connect the heat insulation layer 10 and the fireproof layer 20 on one side. For example, the first connection part 41 can be positioned at a predetermined distance from one edge of the fireproof layer 20.

The second connection part 42 can connect the heat insulation layer 10 and the fireproof layer 20 on the opposite side. For example, the second connection part 42 can be positioned at a predetermined distance from the opposite edge of the fireproof layer 20. The second connection part 42 is spaced apart from the first connection part 41 and can extend in a direction parallel to the first connection part 41.

The third connection part 43 can connect one end of the first connection part 41 to one end of the second connection part 42 and may extend in a direction offset from the directions of the first connection part 41 and the second connection part 42.

The fourth connection part 44 can connect the other end of the first connection part 41 to the other end of the second connection part 42 and may extend in a direction offset from the directions of the first connection part 41 and the second connection part 42. The fourth connection part 44 is spaced apart from the third connection part 43 and can extend in a direction parallel to the third connection part 43.

Hereinafter, the method for manufacturing a thermal runaway prevention film S1 will be described with reference to FIG. 7. The method for manufacturing a thermal runaway prevention film S1 may be a process for producing a thermal runaway prevention film 1 that does not delaminate interlayer even when exposed to flames. The method for manufacturing a thermal runaway prevention film S1 may include a layer providing step S100, a cutting step S200, a laminating step S300, and a sealing step S400.

In the layer providing step S100, the heat insulation layer 10 and the fireproof layer 20 with air adsorbed on their surfaces can be provided. In the layer providing step S100, air on the surfaces of the heat insulation layer 10 and the fireproof layer 20 is adsorbed, ensuring that the heat insulation layer 10 and the fireproof layer 20 are in a smooth state in the cutting step S200. When the air on the surfaces of the heat insulation layer 10 and the fireproof layer 20 is adsorbed during the layer providing step S100, the surface stability of the layers is enhanced. This improvement contributes to better performance and durability of the completed thermal runaway prevention film 1. Although the heat insulation layer 10 and the fireproof layer 20 become smooth enough for cutting after the layer providing step S100, they may not be perfectly flat, which can lead to the formation of an air gap 30 when sealed. The layer providing step S100 can be carried out on an upper plate with a width larger than that of the heat insulation layer 10 and the fireproof layer 20.

In the cutting step S200, the heat insulation layer 10 and the fireproof layer 20 provided in the layer providing step S100 can be cut. During the cutting step S200, the heat insulation layer 10 and the fireproof layer 20 can be cut to have the same width in the horizontal direction and the same length in the vertical direction. The layers cut in the cutting step S200 may have a rectangular shape, although the scope of the present disclosure is not necessarily limited to this form.

In the laminating step S300, the cut heat insulation layer 10 and fireproof layer 20 can be stacked in a vertical direction. The heat insulation layer 10 can be laminated on top of the fireproof layer 20 or between multiple fireproof layers 20.

In the sealing step S400, the stacked heat insulation layer 10 and fireproof layer 20 can be stitched together. For example, the heat insulation layer 10 and the fireproof layer 20 may be stitched at their edges or at positions spaced a predetermined distance from the edges using the sealing member 40. An air gap 30 can be formed inside the stitched heat insulation layer 10 and fireproof layer 20 through the sealing step S400. The air gap 30 may result from the foaming agent inside the heat insulation layer 10 or from small gaps between the heat insulation layer 10 and the fireproof layer 20. The operation and effects of the thermal runaway prevention film 1 with the above-described configuration will now be explained.

TABLE 1

| | Contact surface temperature(° C.)(large | | | | | | |
|---|---|---|---|---|---|---|---|
| | area 10 cm × 10 cm) | | | | | | |
| Types | 1 min | 2 min | 3 min | 4 min | 5 min | 6 min | 7 min |
| Conventional | 182 | 264 | 285 | 287 | 284 | 283 | 283 |
| coated film | | | | | | | |
| Thermal runaway | 215 | 268 | 280 | 278 | 281 | 267 | 271 |
| prevention film 1 | | | | | | | |

Referring to Table 1, the temperature of the contact surface decreases over time in the stitched thermal runaway prevention film 1 compared to conventional coated films. Up to 2 minutes after being engulfed in flames, the contact surface temperature of the stitched thermal runaway prevention film 1 is higher. However, after 3 minutes, the temperature becomes lower in the stitched film. For example, 2 minutes after a fire starts, the temperature of the stitched thermal runaway prevention film 1 may be 4° C. higher than that of the coated film. However, after an additional minute, the coated film's temperature may exceed the stitched film's temperature by 5° C. At 3 minutes after a fire begins, the stitched thermal runaway prevention film 1 may have a temperature 5° C. lower than the coated film, and after 4 minutes, this difference may increase to 9° C. The temperature of the coated film increases rapidly with external temperature changes, whereas the stitched thermal runaway prevention film 1 is less directly affected by such changes. In other words, when the external temperature rises due to a fire, the temperature of the coated film can increase rapidly as it is directly influenced by the external temperature. However, the thermal runaway prevention film 1 may not be directly affected by the increase in external temperature. For instance, when the external temperature rises by 10° C., the temperature of the coated film may increase by approximately 10° C. In contrast, the stitched thermal runaway prevention film 1 may experience a smaller increase of around 5° C.

When the air gap 30 is formed, the temperature of the thermal runaway prevention film 1 may be prevented from directly increasing in response to an external temperature rise. Due to the air contained within the air gap 30, the temperature rise of the thermal runaway prevention film 1 can be mitigated, and the thermal insulation performance may be improved.

Additionally, in the case of coated films, when the film is exposed to high temperatures, the adhesive 50 may melt, leading to interlayer delamination, which can reduce the durability and performance of the film. However, interlayer delamination may not occur in the thermal runaway prevention film 1. When a sealing member 40 that does not melt in flames is used to seal the heat insulation layer 10 and the fireproof layer 20 of the thermal runaway prevention film 1, interlayer delamination may be prevented.

In the case of using coated films as before, two layers containing adhesive 50 were required to bond three layers together. However, when stitching is used to seal multiple layers, there is the advantage of being able to seal all layers in a single process. After vertically stacking multiple layers, stitching from the uppermost layer to the lowermost layer using the sealing member 40 allows all layers to be sealed in a single process.

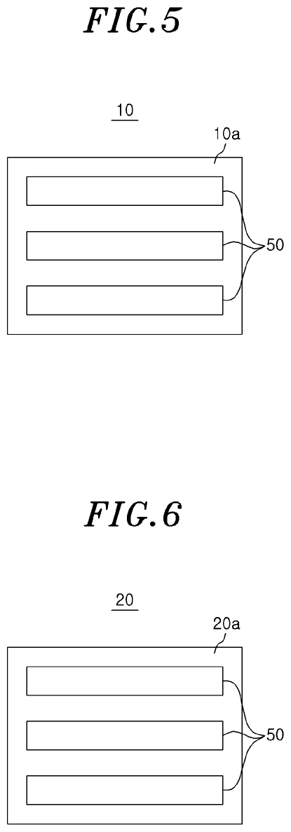

Meanwhile, in addition to the aforementioned configuration, the thermal runaway prevention film 1 according to the second embodiment of the present disclosure may be provided. Hereinafter, the second embodiment of the present disclosure will be described with reference to FIGS. 3 to 5. In describing the second embodiment, the focus will be on the differences compared to the previously described embodiment, while the same explanations as those in the previously described embodiment will be incorporated by reference.

Referring to FIGS. 3 to 5, the thermal runaway prevention film 1 may include an adhesive 50. The adhesive 50 can bond the heat insulation layer 10 and the fireproof layer 20 together between the heat insulation layer 10 and the fireproof layer 20. The adhesive 50 may be in the form of tape or glue, but the scope of the present disclosure is not necessarily limited to these forms. The adhesive 50 may not include flame-retardant materials. Therefore, the adhesive 50 may melt when the thermal runaway prevention film 1 is exposed to flames. Although the adhesive 50 can melt due to flames, if the heat insulation layer 10 and the fireproof layer 20 are also stitched together using the sealing member 40, delamination between the layers may not occur. In other words, even if the thermal runaway prevention film 1 is engulfed in flames and the adhesive 50 melts, the stitched state of the heat insulation layer 10 and the fireproof layer 20 can be maintained because the sealing member 40 does not melt.

Meanwhile, the area where the adhesive 50 is applied between the heat insulation layer 10 and the fireproof layer 20 may be smaller than half the area of the heat insulation layer 10 or the fireproof layer 20. When the adhesive 50 is not applied over the entire area between the heat insulation layer 10 and the fireproof layer 20, an air gap 30 can be formed in the areas where the adhesive 50 is not applied. In other words, an air gap 30 can be formed over an area larger than half the area between the heat insulation layer 10 and the fireproof layer 20. The air gap 30 can help maintain thermal insulation performance.

Hereinafter, the operation and effects of the thermal runaway prevention film 1 with the above-described configuration will be explained.

When the heat insulation layer 10 and the fireproof layer 20 are not only stitched by the sealing member 40 but also bonded by the adhesive 50, the layers can be joined more securely. If the thermal runaway prevention film 1 is engulfed in flames, the adhesive 50 may melt. However, the sealing member 40, which includes flame-retardant materials, may not melt. Therefore, even when the thermal runaway prevention film 1 is exposed to flames, delamination between the heat insulation layer 10 and the fireproof layer 20 may not occur.

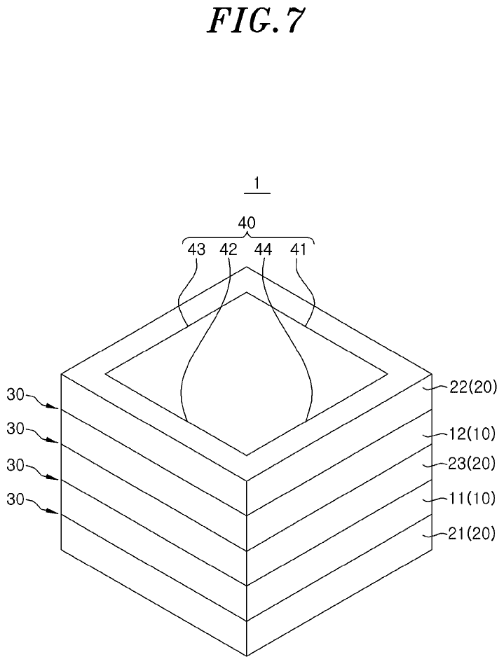

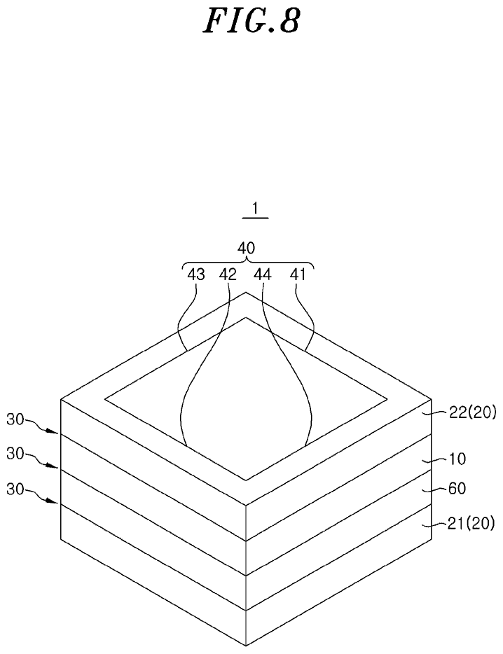

Meanwhile, in addition to the aforementioned configuration, the thermal runaway prevention film 1 according to the third embodiment of the present disclosure may be provided. Hereinafter, the third embodiment of the present disclosure will be described with reference to FIG. 6. In describing the third embodiment, the focus will be on the differences compared to the previously described embodiments, while the same explanations as those in the previously described embodiments will be incorporated by reference.

Referring to FIG. 6, a third fireproof layer 23 may be positioned between the first fireproof layer 21 and the second fireproof layer 22. Additionally, multiple heat insulation layers 10 may be provided. The multiple heat insulation layers 10 may include a first heat insulation layer 11 and a second heat insulation layer 12.

The first heat insulation layer 11 may be positioned between the first fireproof layer 21 and the third fireproof layer 23. The second heat insulation layer 12 may be positioned between the third fireproof layer 23 and the second fireproof layer 22. In other words, the first fireproof layer 21, first heat insulation layer 11, third fireproof layer 23, second heat insulation layer 12, and second fireproof layer 22 may be sequentially stacked.

Hereinafter, the operation and effects of the thermal runaway prevention film 1 with the above-described configuration will be explained.

When using coated films as before, four layers containing adhesive 50 were required to bond five layers together. However, by utilizing stitching to seal multiple layers, all layers can be sealed in a single process. After vertically stacking multiple layers, stitching from the uppermost layer to the lowermost layer using the sealing member 40 allows all layers to be sealed in a single process.

Meanwhile, in addition to the aforementioned configuration, the thermal runaway prevention film 1 according to the fourth embodiment of the present disclosure may be provided. Hereinafter, the fourth embodiment of the present disclosure will be described with reference to FIG. 7. In describing the fourth embodiment, the focus will be on the differences compared to the previously described embodiments, while the same explanations as those in the previously described embodiments will be incorporated by reference.

Referring to FIG. 7, the conductive layer 60 can transfer heat through at least one of the heat insulation layer 10 and the fireproof layer 20. The conductive layer 60 may include a material with a higher thermal conductivity than that of the heat insulation layer 10 and the fireproof layer 20. The conductive layer 60 can be provided in the same size as the heat insulation layer 10 and the fireproof layer 20. The conductive layer 60 may be positioned between the first fireproof layer 21 and the heat insulation layer 10. In other words, the first fireproof layer 21, the conductive layer 60, the heat insulation layer 10, and the second fireproof layer 22 may be sequentially stacked.

Hereinafter, the operation and effects of the thermal runaway prevention film 1 with the above-described configuration will be explained.

When using coated films as before, three layers containing adhesive 50 were required to bond four layers together. However, by utilizing stitching to seal multiple layers, all layers can be sealed in a single process.

Although the embodiments of the present disclosure have been described as specific embodiments, this is merely an example, and the present disclosure should be construed as having the broadest scope according to the technical idea disclosed herein without being limited thereto. Those skilled in the art may implement a pattern of a shape not indicated herein by combining/substituting the disclosed embodiments, but this also does not deviate from the scope of the present disclosure. In addition, those skilled in the art may easily change or modify the disclosed embodiments based on the present specification, and it is clear that such changes or modifications also fall within the scope of the present disclosure.

What is claimed is:

1. An thermal runaway prevention film comprising:
a heat insulation layer blocking heat transfer;
a fireproof layer disposed to face with the heat insulation layer; and
a sealing member sealing the heat insulation layer and the fireproof layer,
wherein the sealing member has a string shape,
wherein the heat insulation layer, the fireproof layer, and the sealing member include a flame-retardant material, and
wherein the fireproof layer includes:
a first fireproof layer disposed to face with one surface of the heat insulation layer, and
a second fireproof layer disposed to face with the other surface of the heat insulation layer.

2. The thermal runaway prevention film of claim 1, wherein the heat insulation layer and the multiple fireproof layers are sealed by the sealing member without using an adhesive, and
wherein the heat insulation layer and the fireproof layer directly face with each other.

3. The thermal runaway prevention film of claim 1, wherein at least one of the heat insulation layer or the multiple fireproof layers contains a foaming agent.

4. The thermal runaway prevention film of claim 1, further comprising an air gap that slows temperature rises of the heat insulation layer and the multiple fireproof layers,
wherein the air gap is formed between the heat insulation layer and the fireproof layer, and
wherein the air gap reduces a pressure between the heat insulation layer and the fireproof layer.

5. The thermal runaway prevention film of claim 4, wherein the heat insulation layer includes an opposing surface facing with the fireproof layer,
wherein the fireproof layer includes an opposing surface facing with the heat insulation layer, and
wherein the air gap is provided by a plurality of recesses formed on at least one of the opposing surface of the heat insulation layer and the opposing surface of the fireproof layer.

6. The thermal runaway prevention film of claim 4, wherein the sealing member includes:
a first connection part that connects the heat insulation layer and the fireproof layer to each other on one side of the heat insulation layer, and
a second connection part that connects the heat insulation layer and the fireproof layer to each other on the other side of the heat insulation layer, and
wherein the air gap is provided by bending at least one of the heat insulation layer and the fireproof layer between the first connection part and the second connection part.

7. The thermal runaway prevention film of claim 1, wherein the heat insulation layer has a thermal conductivity ranging from about 0.001 W/mK to 10 W/mK.

8. The thermal runaway prevention film of claim 1, wherein the fireproof layer corresponds to flame retardant grades 1 to 3 according to KS standard and meets V0 and 5VA ratings according to UL 94 standard.

9. The thermal runaway prevention film of claim 1, further comprising an adhesive disposed between the heat insulation layer and the fireproof layer to adhering to the heat insulation layer and the fireproof layer,
wherein an area of the adhesive in contact with the heat insulation layer or the fireproof layer is less than half of a total area of the heat insulation layer or the fireproof layer.

10. The thermal runaway prevention film of claim 1, wherein the fireproof layer includes a third fireproof layer disposed between the first fireproof layer and the second fireproof layer, and
wherein the heat insulation layer includes:
a first heat insulation layer disposed between the first fireproof layer and the third fireproof layer, and
a second heat insulation layer disposed between the third fireproof layer and the second fireproof layer.

11. The thermal runaway prevention film of claim 1, further comprising a conductive layer that transfers heat in at least one of the heat insulation layer and the fireproof layer,
wherein the conductive layer is disposed between the first fireproof layer and the heat insulation layer.

12. The thermal runaway prevention film of claim 1, wherein the sealing member essentially consists of a flame-retardant thread.

13. A method for manufacturing a thermal runaway prevention film performed by a manufacturing apparatus, comprising:
providing an heat insulation layer blocking heat transfer and including a flame-retardant material, and multiple fireproof layers disposed to face with the heat insulation layer and including a flame-retardant material by absorbing air adjacent to surfaces of the heat insulation layer and the fireproof layers; and
sealing the heat insulation layer and the multiple fireproof layers by stitching the heat insulation layer with the multiple fireproof layers using a sealing member.

14. The method for manufacturing the thermal runaway prevention film of claim 13, further comprising:
cutting the heat insulation layer and the multiple fireproof layers into a predetermined size; and
laminating the heat insulation layer between the multiple fireproof layers.

15. The method for manufacturing a thermal runaway prevention film of claim 14,
wherein the heat insulation layer and the multiple fireproof layers laminated in the laminating step are sealed using the sealing member in the sealing step.
